(19) United States
(12) Patent Application Publication
(10) Pub. No.: US 2018/0126561 A1
(43) Pub. Date: May 10, 2018

(54) GENERATION DEVICE, CONTROL METHOD, ROBOT DEVICE, CALL SYSTEM, AND COMPUTER-READABLE RECORDING MEDIUM

(71) Applicant: FUJITSU LIMITED, Kawasaki-shi (JP)

(72) Inventors: Akihiro Takahashi, Kawasaki (JP); Shota Niikura, Machida (JP); Mitsuru Hanada, Kawasaki (JP); Tetsuya Okano, Setagaya (JP)

(73) Assignee: FUJITSU LIMITED, Kawasaki-shi (JP)

(21) Appl. No.: 15/785,597

(22) Filed: Oct. 17, 2017

(30) Foreign Application Priority Data
Nov. 8, 2016 (JP) 2016-218471

(51) Int. Cl. B25J 11/00; G06F 3/16; G10L 13/08; G06N 3/00

(52) U.S. Cl. CPC B25J 11/0005; G06F 3/16; G10L 15/22; G06N 3/008; B25J 11/0015; G10L 13/08

(57) ABSTRACT

A non-transitory computer-readable recording medium stores a generation program that causes a computer to execute a process including: acquiring a character string recognized from a voice of a speaker, and data representing a movement of the speaker in a period corresponding to a period in which the voice is output; and generating information indicating a correspondence relationship between a character string and a movement based on the acquired character string and the acquired data representing the movement.

### CROSS-REFERENCE TO RELATED APPLICATION

This application is based upon and claims the benefit of priority of the prior Japanese Patent Application No. 2016-218471, filed on Nov. 8, 2016, the entire contents of which are incorporated herein by reference.

### FIELD

The embodiments discussed herein are related to a computer-readable recording medium, a generation device, a control method, a robot device, and a call system.

### BACKGROUND

Robot devices that output voices and dialogue with humans have been proposed. Some of the robot devices that carry on dialogues as described above operate movable parts, such as faces, arms, or legs, to express themselves or perform behaviors during dialogues.
Patent Document 1: Japanese Laid-open Patent Publication No. 2007-216363

### SUMMARY

According to an aspect of the embodiment, a non-transitory computer-readable recording medium stores a generation program that causes a computer to execute a process including: acquiring a character string recognized from a voice of a speaker, and data representing a movement of the speaker in a period corresponding to a period in which the voice is output; and generating information indicating a correspondence relationship between a character string and a movement based on the acquired character string and the acquired data representing the movement.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a configuration example of a call system in a first embodiment;

FIG. 2 is a diagram for explaining an example of a dialogue between a human and a robot device;

FIG. 3 is a diagram illustrating an example of functional blocks of a call device in the first embodiment;

FIG. 4 is a diagram illustrating an example of functional blocks of a generation device in the first embodiment;

FIG. 5 is a diagram illustrating an example of acquired data;

FIG. 6 is a diagram illustrating an example of a learning result DB;

FIG. 7 is a diagram illustrating an example of functional blocks of the robot device in the first embodiment;

FIG. 8 is a diagram for explaining an example of an exterior of the robot device;

FIG. 9 is a diagram for explaining an example of driving of the robot device;

FIG. 10 is a diagram for explaining an example of a driving period of the robot device;

FIG. 11 is a diagram for explaining an example of a generation process in the first embodiment;

FIG. 12 is a diagram for explaining an example of a response process in the first embodiment;

FIG. 13 is a diagram illustrating an example of functional blocks of a robot device in a second embodiment;

FIG. 14 is a diagram for explaining an example of a response process in the second embodiment; and

FIG. 15 is a block diagram illustrating an example of a hardware configuration of the generation device.

### DESCRIPTION OF EMBODIMENTS

However, in the technology as described above, it may be difficult to cause a robot device to perform a wide variety of movements in some cases. For example, a robot device in the above-described technology performs a movement designed in advance, depending on situations or in a random manner. Therefore, it is difficult to cause the robot device to perform a movement that is not designed yet.

Preferred embodiments will be explained with reference to accompanying drawings. The disclosed technology is not limited by the embodiments below. The embodiments described below may be combined appropriately within a scope in which no contradiction is derived.

### [a] First Embodiment

Outline of System

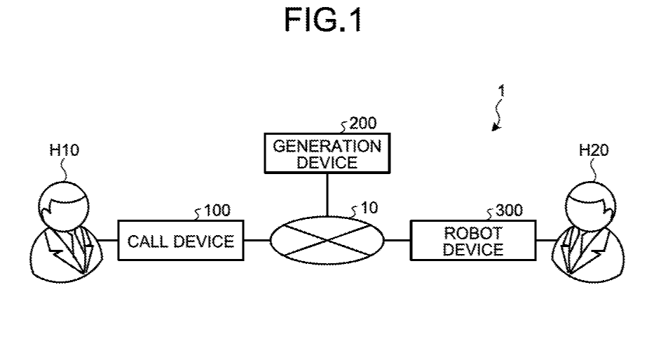

First, an outline of a call system 1 will be described with reference to FIG. 1. FIG. 1 is a diagram for explaining a configuration example of the call system in a first embodiment. As illustrated in FIG. 1, the call system 1 includes a call device 100, a generation device 200, and a robot device 300. The call device 100, the generation device 200, and the robot device 300 are communicably connected to one another via a communication network 10 that is established in a wireless or wired manner. The communication network 10 is, for example, the Internet. The generation device 200 is one example of an information processing apparatus.

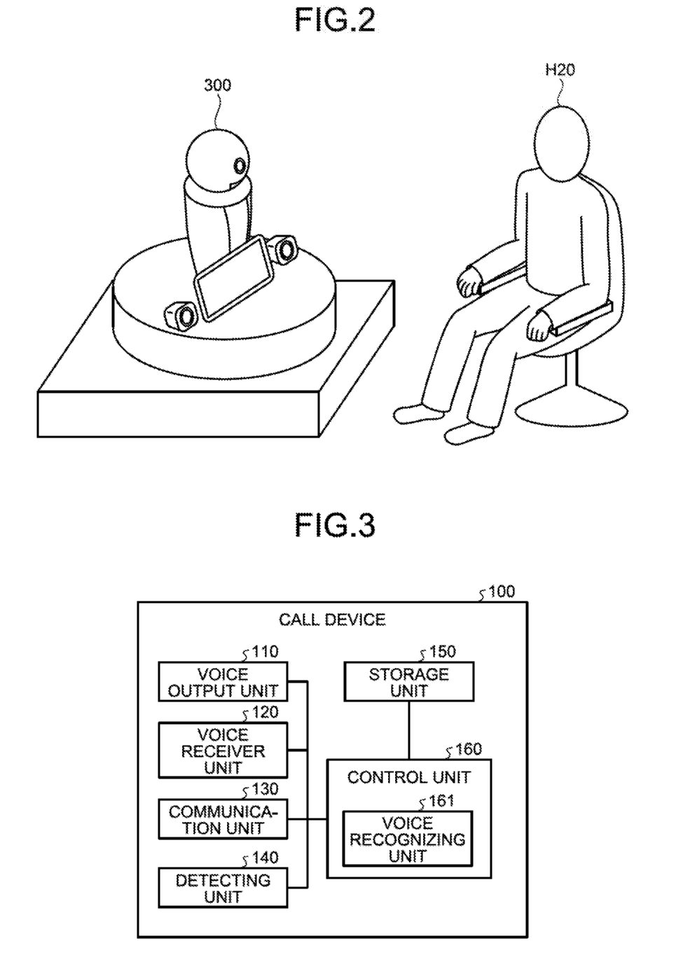

The call device 100 is a device that has a voice call function. The call device 100 is, for example, a smartphone or the like. The robot device 300 is a human interface device that has a data communication function, a function to collect a voice on the periphery, a function to capture a video image, a function to output a voice and a video image, a voice recognition function, a function to drive a movable part, and the like. The call system 1 causes the robot device 300 to dialogue with a user H20. As illustrated in FIG. 2, with the call system 1, the user H20 can perform a face-to-face dialogue with the robot device 300. FIG. 2 is a diagram for explaining an example of a dialogue between a human and the robot device.

For example, the robot device 300 may be configured to automatically dialogue with the user H20 according to a scenario or a program set in advance. In this case, for example, the robot device 300 collects a voice output by the user H20, extracts a character string from the collected voice through voice recognition, and outputs a predetermined voice as a response to the extracted character string.

Furthermore, the robot device 300 may be configured to function as a call device. In this case, for example, the robot device 300 acquires a voice of a user H10 who uses the call device 100 via the call device 100 and the communication network 10, and outputs the acquired voice. In addition, the robot device 300 collects a voice of the user H20 and transmits the collected voice to the call device 100 via the communication network 10. In this case, the user H20 can make a call to the user H10 as if the user H20 dialogues with the robot device 300.

Furthermore, the robot device 300 can virtually display emotional expressions or behaviors of a human at the time of a dialogue by outputting a voice and driving a movable part, such as a head portion or an arm portion. In the first embodiment, when determining how to drive the movable part, the robot device 300 uses learning data that is generated in advance through machine learning or the like based on a voice, a movement, or the like of a human. With this configuration, it becomes possible to cause the robot device 300 to perform a wide variety of movements. The generation device 200 is a device for generating learning data.

Functional Configuration

FIG. 3 is a diagram illustrating an example of functional blocks of the call device in the first embodiment. The call device 100 illustrated in FIG. 3 includes a voice output unit 110, a voice receiver unit 120, a communication unit 130, a detecting unit 140, a storage unit 150, and a control unit 160. The call device 100 may include various functional units included in a known computer, such as functional units of various communication devices, input devices, voice output devices, or the like, in addition to the functional units illustrated in FIG. 3. As one example of the call device 100, a smartphone, a tablet terminal or a personal computer with a call function, or the like may be used.

The voice output unit 110 is a device that outputs a voice. For example, the voice output unit 110 outputs a voice of an intended party during a call. The voice output unit 110 is, for example, a speaker. The voice receiver unit 120 is a device that collects a voice. For example, the voice receiver unit 120 collects a voice of the user H10 during a call. The voice receiver unit 120 is, for example, a microphone.

The communication unit 130 controls communication with other computers via the communication network 10. For example, the communication unit 130 transmits and receives data to and from the generation device 200 and the robot device 300. The communication unit 130 transmits, to the generation device 200, data related to a movement of a speaker acquired by the detecting unit 140 and a character string obtained as a result of voice recognition performed by a voice recognizing unit 161, which will be described below.

The detecting unit 140 is a sensor that detects a movement of a speaker who is making a call by using the call device 100. For example, when the call device 100 is a mobile device, such as a smartphone, the detecting unit 140 may be a sensor, such as an acceleration sensor or a gyroscope sensor, which detects a movement of the device itself. This is because, when the call device 100 is a mobile device, the speaker and the call device 100 are in close contact with each other during a call, and the call device 100 itself moves in accordance with a movement of the speaker.

Furthermore, the detecting unit 140 may include a camera. In this case, the detecting unit 140 can acquire data related to a movement of a speaker by analyzing an image of the speaker captured by the camera.

The storage unit 150 is implemented by a storage device, such as a semiconductor memory device including a random access memory (RAM) or a flash memory, a hard disk, an optical disk, or the like. Furthermore, the storage unit 150 stores therein information used for a process performed by the control unit 160.

The control unit 160 is implemented by, for example, causing a central processing unit (CPU), a micro processing unit (MPU), or the like to execute a program stored in an internal storage device by using a RAM as a work area. Furthermore, the control unit 160 may be implemented by, for example, an integrated circuit, such as an application specific integrated circuit (ASIC) or a field programmable gate array (FPGA). The control unit 160 includes the voice recognizing unit 161, and implements or executes functions or effects of information processing as described below. The internal configuration of the control unit 160 is not limited to the configuration illustrated in FIG. 3, and other configurations may be applied as long as the information processing is performed.

The voice recognizing unit 161 performs voice recognition. Specifically, the voice recognizing unit 161 extracts a human voice from voices collected by the voice receiver unit 120, by using a well-known voice recognition technique. Then, the voice recognizing unit 161 refers to dictionary data of words to be recognized based on the extracted human voice, and extracts a content of a conversation made by a human as a character string. Furthermore, the voice recognizing unit 161 may break down the extracted character string into certain units, such as words, by using morphological analysis or the like.

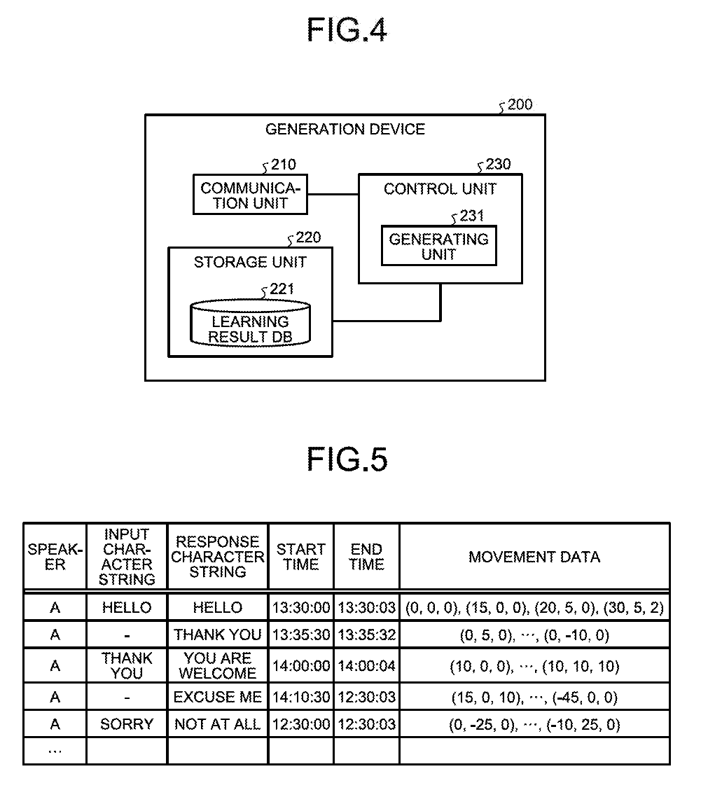

FIG. 4 is a diagram illustrating an example of functional blocks of the generation device in the first embodiment. The generation device 200 illustrated in FIG. 4 includes a communication unit 210, a storage unit 220, and a control unit 230. The generation device 200 may include various functional units included in a known computer, such as functional units of various communication devices, input devices, voice output devices, or the like, in addition to the functional units illustrated in FIG. 4. As one example of the generation device 200, a server on a cloud system or the like may be used.

The communication unit 210 controls communication with other computers via the communication network 10. For example, the communication unit 210 transmits and receives data to and from the call device 100 and the robot device 300. The communication unit 210 receives, from the call device 100, data related to a movement of a speaker acquired by the detecting unit 140 and a character string obtained as a result of voice recognition performed by the voice recognizing unit 161. Accordingly, the communication unit 210 acquires the character string recognized from the voice of the speaker, and acquires data representing the movement of the speaker in a period corresponding to a period in which the voice is output. The communication unit 210 is one example of an acquiring unit.

The storage unit 220 is implemented by a storage device, such as a semiconductor memory device including a RAM or a flash memory, a hard disk, an optical disk, or the like. The storage unit 220 includes a learning result DB 221. Furthermore, the storage unit 220 stores therein information used for a process performed by the control unit 230.

The control unit 230 is implemented by, for example, causing a CPU, an MPU, or the like to execute a program stored in an internal storage device by using a RAM as a work area. Furthermore, the control unit 230 may be implemented by, for example, an integrated circuit, such as an ASIC or an FPGA. The control unit 230 includes a generating unit 231, and implements or executes functions or effects of information processing as described below. The internal configuration of the control unit 230 is not limited to the configuration illustrated in FIG. 4, and other configurations may be applied as long as the information processing is performed.

The generating unit 231 generates information indicating a correspondence relationship between a character string and a movement, based on the acquired character string and the data representing the movement of the speaker. The generating unit 231 generates learning data by using, for example, a machine learning method, such as linear regression or a support vector machine (SVM), and stores the generated data in the learning result DB 221. A series of processes performed by the generating unit 231 to generate information and store the generated information in the learning result DB 221 may be referred to as learning.

Acquired data that is acquired by the generation device 200 from the call device 100 will be described below with reference to FIG. 5. FIG. 5 is a diagram illustrating an example of the acquired data. As illustrated in FIG. 5, the acquired data includes items, such as a “speaker”, an “input character string”, a “response character string”, a “start time”, an “end time”, and “movement data”. The acquired data stores therein a record for each of words broken down through morphological analysis. The acquired data may store therein a record for each paragraph or each sentence.

In FIG. 5, the “speaker” is an ID or the like for identifying a user who has made a call by using the call device 100. In this manner, the communication unit 210 acquires data for identifying a speaker. In FIG. 5, the “input character string” is a word based on a voice that is output by an intended party just before the speaker replies. In FIG. 5, the “response character string” is a word based on a voice output by the speaker. In FIG. 5, the “start time” is a time at which the speaker starts output of a voice of the “response character string”. In FIG. 5, the “end time” is a time at which the speaker ends the output of the voice of the “response character string”. In FIG. 5, the “movement data” is data that represents a movement of the speaker during a period from the start to the end of the output of the voice of the “response character string” by the speaker, and that is acquired by the detecting unit 140.

In this example, the “movement data” in FIG. 5 is data detected by the detecting unit 140, and indicates angles of rotation about the x-axis, the y-axis, and the z-axis acquired at predetermined time intervals (a range of the angles of rotation is set to −180° to 180°). For example, if the angles of rotation about the x-axis, the y-axis, and the z-axis acquired at a certain time point are θₓ, θ_{y}, and θ_{z}, an inclination at this time point is represented by “(θₓ, θ_{y}, θ_{z})”. Furthermore, the “movement data” is data indicating a change in the inclination, and represented by “(θₓ₁, θ_{y1}, θ_{z1}), (θₓ₂, θ_{y2}, θ_{z2}), . . . , (θₓₙ, θ_{yn}, θ_{zn})”.

Therefore, the generation device 200 can receive data on a movement in a compact format. Furthermore, the generation device 200 receives the data on the movement together with the response character string, the start time, and the end time, and therefore can receive the data in which the voice output and the movement are accurately synchronized.

For example, a record in the first row of the acquired data in FIG. 5 indicates that a speaker “A” has output a voice of a response character string of “hello” in a time from “13:30:00” to “13:30:03” in response to an input character string of “hello”. Furthermore, this record indicates that an inclination detected by the detecting unit 140 has changed as represented by “(0, 0, 0), (15, 0, 0), (20, 5, 0), (30, 5, 2)”.

In this manner, the communication unit 210 acquires a character string recognized from a voice of a speaker who uses the call device 100 and data indicating an inclination of the call device 100 in a period corresponding to a period in which the voice is output. In this case, the generating unit 231 generates information indicating a correspondence relationship between the character string and the inclination.

Furthermore, the “input character string” does not necessarily have to be included in the acquired data; therefore, it may be possible that the acquired data includes a record that does not include the “input character string”, or all of records in the acquired data do not include the “input character string”. Moreover, the acquired data may include a time from the start to the end of output of a voice of the “response character string”, instead of the “start time” and the “end time”. Furthermore, the “movement data” does not necessarily have to be represented in the same manner as the example illustrated in FIG. 5, but may be represented in an arbitrary manner.

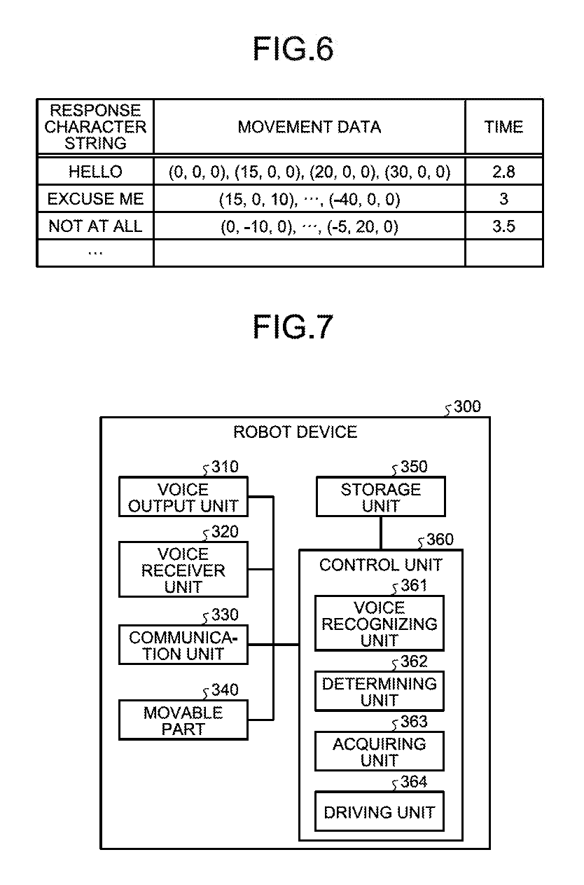

Next, the learning result DB 221 for storing a learning result obtained by the generation device 200 will be described with reference to FIG. 6. FIG. 6 is a diagram illustrating an example of the learning result DB. As illustrated in FIG. 6, the learning result DB 221 includes items, such as a “response character string”, “movement data”, and a “time”. The learning result DB 221 stores therein a record for each response character string. The generating unit 231 may generate information indicating a correspondence relationship for each speaker. In this case, an item “speaker” is added to the learning result DB 221.

In FIG. 6, the “response character string” is a character string of a voice output by the robot device 300. In FIG. 6, the “movement data” is data that represents a movement of the robot device 300 during a period from the start to the end of the output of the voice of the “response character string” by the robot device 300. In FIG. 6, the “time” is a time in which the movement indicated by the “movement data” is performed. The “movement data” in FIG. 6 indicates angles of rotation about the x-axis, the y-axis, and the z-axis (a range of the angles of rotation is set to −180° to 180°), similarly to the “movement data” in FIG. 5. The robot device 300 drives the movable part such that the angles of rotation of the movable part match the angles indicated by the “movement data”.

For example, a record in the first row of the learning result DB in FIG. 6 indicates that the robot device 300 changes the angles of rotation of the movable part in a time of “2.8” seconds while the robot device 300 outputs a voice of a response character string of “hello”. At this time, the robot device 300 changes the angles of rotation as represented by “(0, 0, 0), (15, 0, 0), (20, 0, 0), (30, 0, 0)”. The movable part driven by the robot device 300 is, for example, a head portion, an arm portion, or the like. The learning result DB 221 may store therein data on a movement in association with the movable part.

FIG. 7 is a diagram illustrating an example of functional blocks of the robot device in the first embodiment. The robot device 300 illustrated in FIG. 7 includes a voice output unit 310, a voice receiver unit 320, a communication unit 330, a movable part 340, a storage unit 350, and a control unit 360. The robot device 300 may include various functional units included in a known interactive robot device, such as functional units of a light-emitting device, various sensors, or the like, in addition to the functional units illustrated in FIG. 7.

The voice output unit 310 is a device that outputs a voice based on a predetermined character string. For example, the voice output unit 310 can output a voice generated based on a response character string that is determined by a predetermined method. Furthermore, the voice output unit 310 can output a voice of an intended party during a call. The voice output unit 310 is, for example, a speaker. The voice receiver unit 320 is a device that collects a voice. For example, the voice receiver unit 320 collects a voice of the user H20 during a dialogue. The voice receiver unit 320 is, for example, a microphone.

The communication unit 330 controls communication with other computers via the communication network 10. For example, the communication unit 330 transmits and receives data to and from the call device 100 and the generation device 200. The communication unit 330 acquires data stored in the learning result DB 221 from the generation device 200.

The movable part 340 is a movable portion equipped in the robot device 300. For example, the movable part 340 is a head portion, an arm portion, a leg portion, or the like equipped in the robot device 300. The movable part 340 is operated by a motor or the like. The movable part 340 can perform a rotation movement about a predetermined axis, for example. The movable part 340 may be configured to perform a bending and stretching movement.

The storage unit 350 is implemented by a storage device, such as a semiconductor memory device including a RAM or a flash memory, a hard disk, an optical disk, or the like. Furthermore, the storage unit 350 stores therein information used for a process performed by the control unit 360.

The control unit 360 is implemented by, for example, causing a CPU, an MPU, or the like to execute a program stored in an internal storage device by using a RAM as a work area. Furthermore, the control unit 360 may be implemented by, for example, an integrated circuit, such as an ASIC or an FPGA. The control unit 360 includes a voice recognizing unit 361, a determining unit 362, an acquiring unit 363, and a driving unit 364, and implements or executes functions or effects of information processing as described below. The internal configuration of the control unit 360 is not limited to the configuration illustrated in FIG. 7, and other configurations may be applied as long as the information processing is performed.

The voice recognizing unit 361 performs voice recognition, similarly to the voice recognizing unit 161 of the call device 100. Specifically, the voice recognizing unit 361 extracts a human voice from the voice collected by the voice receiver unit 320, by using a well-known voice recognition technique. Then, the voice recognizing unit 361 refers to dictionary data of words to be recognized based on the extracted human voice, and extracts a content of a conversation made by a human as a character string. Furthermore, the voice recognizing unit 361 may break down the extracted character string into certain units, such as words, by using morphological analysis or the like.

The determining unit 362 determines a response character string that is a character string of a voice output by the voice output unit 310, based on the character string extracted by the voice recognizing unit 361. For example, it may be possible to store a predetermined word as the response character string in the storage unit 350 for each of words extracted by the voice recognizing unit 361. Furthermore, the determining unit 362 may determine the response character string by a method used in a known interactive robot device.

The acquiring unit 363 acquires data for driving the movable part 340 based on the response character string determined by the determining unit 362. Specifically, the acquiring unit 363 refers to the learning result DB 221 of the generation device 200, and acquires “movement data” and a “time” of a record whose item of “response character string” matches the response character string determined by the determining unit 362. For example, in FIG. 6, if the response character string determined by the determining unit 362 is “hello”, the acquiring unit 363 acquires movement data of “(0, 0, 0), (15, 0, 0), (20, 0, 0), (30, 0, 0)” and a time of “2.8”.

The driving unit 364 drives the movable part 340 in synchronization with output of a voice performed by the voice output unit 310, in accordance with the movement data and the time acquired by the acquiring unit 363. For example, when the acquiring unit 363 acquires the movement data of “(0, 0, 0), (15, 0, 0), (20, 0, 0), (30, 0, 0)” and the time of “2.8”, the driving unit 364 changes the angles of rotation of the movable part 340 as represented by “(0, 0, 0), (15, 0, 0), (20, 0, 0), (30, 0, 0)” in a time of “2.8” seconds.

The acquiring unit 363 acquires, from the learning result DB 221, information indicating a correspondence relationship between a character string and a movement, which is generated based on a character string recognized from a voice of a speaker and data representing a movement of the speaker in a period corresponding to a period in which the voice is output. Then, the movable part 340 performs a movement corresponding to a predetermined character string in synchronization with output of a voice performed by the voice output unit 310, based on the information indicating the correspondence relationship acquired by the acquiring unit 363. The movable part 340 is one example of an operating unit.

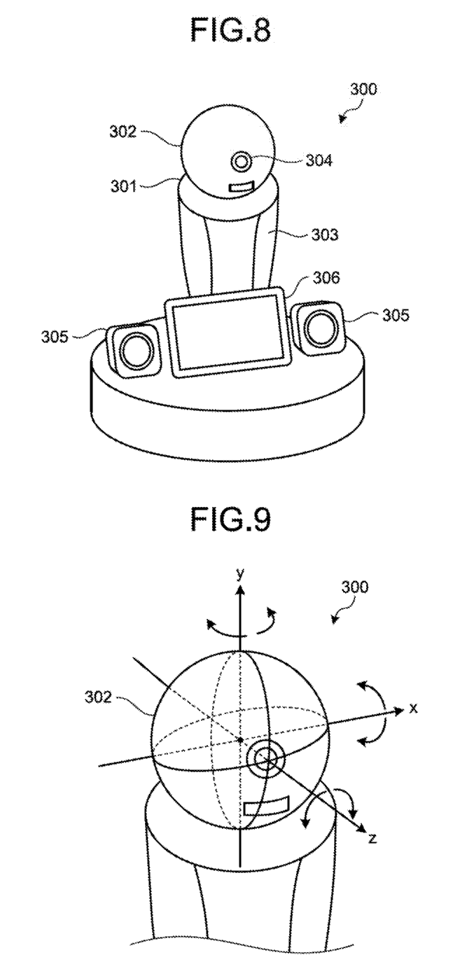

With reference to FIG. 8, an exterior of the robot device 300 will be described. FIG. 8 is a diagram for explaining an example of the exterior of the robot device. As illustrated in FIG. 8, the robot device 300 includes a body portion 301, a head portion 302, an arm portion 303, an imaging unit 304, voice input/output units 305, and a touch panel 306. The body portion 301, the head portion 302, and the arm portion 303 can function as the movable part 340. The imaging unit 304 is a camera that captures a video image. The voice input/output units 305 are microphones for collecting a voice and speakers for outputting a voice. The touch panel 306 displays a screen for a user and receives a touch operation from the user.

The configuration of the robot device 300 is one example, and is not limited to the example illustrated in the drawings. For example, the robot device 300 may be an autonomous robot that includes a vehicle device or an ambulation device below the body portion 301, and that moves so as to follow a user based on an image captured by the imaging unit 304.

With reference to FIG. 9, driving of the robot device will be described. FIG. 9 is a diagram for explaining an example of the driving of the robot device. FIG. 9 illustrates an example in which the movable part 340 is the head portion 302 of the robot device 300. As illustrated in FIG. 9, the head portion 302 can rotate about the x-axis, the y-axis, and the z-axis. The driving unit 364 changes the angles of rotation of the movable part 340.

If the driving unit 364 changes the angles of rotation of the head portion 302 as represented by (0, 0, 0), (15, 0, 0), (20, 0, 0), (30, 0, 0) in 2.8 seconds, the angle of rotation about the x-axis is increasing. At this time, the robot device 300 can express a human's movement of raising a face.

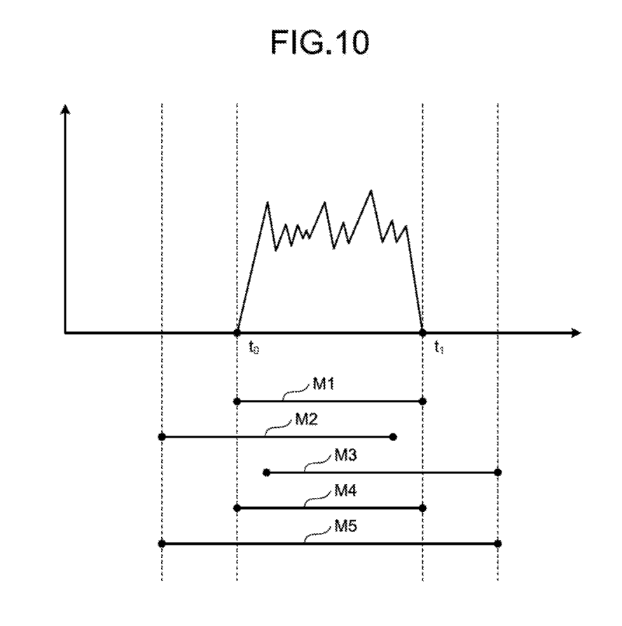

Furthermore, the driving unit 364 may drive the movable part 340 simultaneously when the voice output unit 310 starts to output a voice, or at an arbitrary timing. With reference to FIG. 10, a driving period of the robot device 300 will be described. FIG. 10 is a diagram for explaining an example of the driving period of the robot device. A waveform in FIG. 10 chronologically represents a voice that is obtained when the voice output unit 310 outputs a character string representing a predetermined word. Furthermore, t₀ is a time at which the voice output unit 310 starts output of a voice. Moreover, t₁ is a time at which the voice output unit 310 ends the output of the voice.

When a person performs a movement while outputting a voice, in some cases, the person may start to move before starting to output a voice or may start to move after starting to output a voice. Therefore, if a time at which the movable part 340 starts to operate is shifted forward or backward relative to a time at which the voice output unit 310 starts to output a voice, it may become possible to cause the robot device 300 to move more naturally in some cases.

For example, the driving unit 364 may drive the movable part 340 in a period indicated by M1 in FIG. 10. In this case, output of a voice by the voice output unit 310 and a movement of the movable part 340 start and end simultaneously. Furthermore, the driving unit 364 may drive the movable part 340 in a period indicated by M2 in FIG. 10. In this case, a movement of the movable part 340 starts before the voice output unit 310 outputs a voice. Moreover, the driving unit 364 may drive the movable part 340 in periods indicated by M3 to M5 in FIG. 10, or may drive the movable part 340 in an arbitrary period that is not illustrated in FIG. 10.

Flow of Process

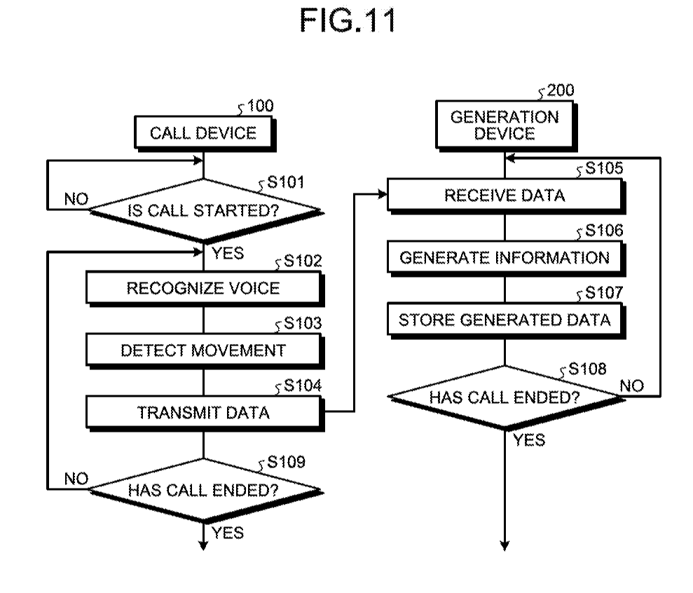

With reference to FIG. 11, the flow of a generation process performed by the call device 100 and the generation device 200 according to the first embodiment will be described. FIG. 11 is a diagram for explaining an example of the generation process in the first embodiment. As illustrated in FIG. 11, the call device 100 waits until a call starts (NO at Step S101). If a call starts (YES at Step S101), the voice recognizing unit 161 of the call device 100 performs voice recognition on voices collected by the voice receiver unit 120 (Step S102). Furthermore, the detecting unit 140 detects a movement of a speaker (Step S103). Then, the communication unit 130 transmits, to the generation device 200, a character string obtained as a result of the voice recognition performed by the voice recognizing unit 161 and data on the movement of the speaker acquired by the detecting unit 140 (Step S104).

The communication unit 210 of the generation device 200 receives the character string and the data on the movement of the speaker transmitted by the communication unit 130 (Step S105). Then, the generating unit 231 generates information indicating a correspondence relationship between the character string and the data on the movement of the speaker (Step S106), and stores a learning result in the learning result DB 221 of the storage unit 220 (Step S107).

At this time, if the call has not ended (NO at Step S108), that is, if there is data that has not yet been learned, the generation device 200 further receives data transmitted by the call device 100 (Step S105), and generates data. If the call has ended (YES at Step S108), that is, if there is no data that has not yet been learned, the generation device 200 ends the process. To cause the generation device 200 to determine whether the call has ended or not, the call device 100 may add, to data to be transmitted, a flag indicating that the data is last data.

Furthermore, if the call has not ended (NO at Step S109), the call device 100 further performs voice recognition (Step S102). If the call has ended (YES at Step S109), the call device 100 ends the process.

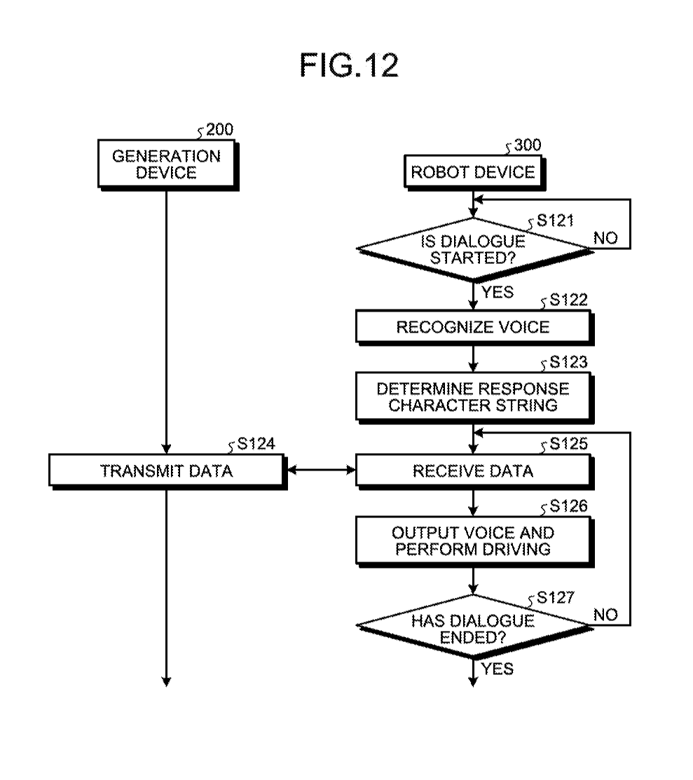

With reference to FIG. 12, the flow of a response process performed by the generation device 200 and the robot device 300 according to the first embodiment will be described. FIG. 12 is a diagram for explaining an example of the response process in the first embodiment. As illustrated in FIG. 12, the robot device 300 waits until a dialogue starts (NO at Step S121). If a dialogue starts (YES at Step S121), the voice recognizing unit 361 of the robot device 300 performs voice recognition on voices collected by the voice receiver unit 320 (Step S122). Then, the determining unit 362 determines a response character string based on a character string recognized by the voice recognizing unit 361 (Step S123).

The generation device 200 transmits, to the robot device 300, data on a movement corresponding to the response character string determined by the determining unit 362, in response to a request from the acquiring unit 363 (Step S124). Then, the acquiring unit 363 receives the data on the movement transmitted by the generation device 200 (Step S125). Subsequently, the voice output unit 310 outputs a voice. At this time, the driving unit 364 performs driving based on the data on the movement transmitted by the generation device 200 (Step S126).

At this time, if the dialog has not ended (NO at Step S127), the robot device 300 further receives data (Step S125). If the dialog has ended (YES at Step S127), the robot device 300 ends the process.

Effects

According to the generation device 200 of the first embodiment, it is possible to learn a relationship between a voice and a movement based on an actual voice and an actual movement of a user who makes a call by using the call device 100. Therefore, the robot device 300 according to the first embodiment can perform a wide variety of movements. For example, according to the first embodiment, the robot device 300 can perform behaviors more like a human. Therefore, according to the first embodiment, it becomes possible for families in remote locations to dialogue with each other via the robot device 300.

Furthermore, according to the first embodiment, it is possible to easily increase movements of the robot device 300 by increasing the number of pieces of the learning data. Moreover, by employing data indicating an inclination of the call device 100 as data on a movement, it becomes possible to easily collect data by using a function of a smartphone or the like.

### [b] Second Embodiment

While the embodiment of the disclosed technology has been described above, the disclosed technology may be embodied in various different forms other than the embodiment as described above. For example, while an example has been described in the first embodiment in which the acquiring unit 363 of the robot device 300 acquires movement data from the generation device 200 every time the driving unit 364 performs driving, the disclosed technology is not limited to this example.

For example, the robot device 300 may acquire, in advance, data on a movement needed for driving. In this case, the acquiring unit 363 of the robot device 300 need not acquire the movement data from the generation device 200 every time the driving unit 364 performs driving.

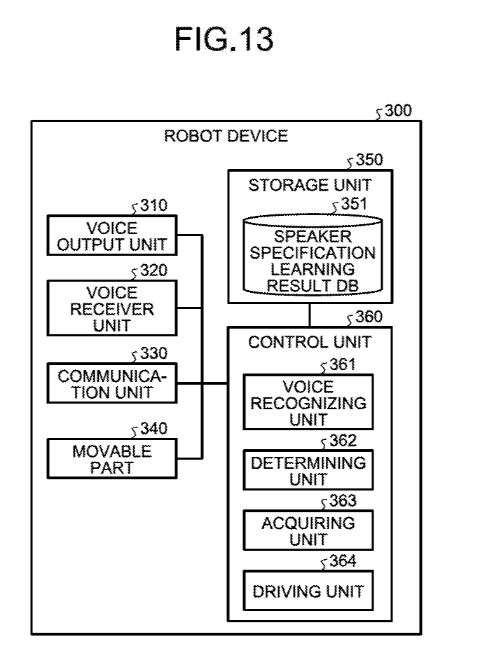

The robot device 300 according to a second embodiment is implemented by the same configuration as that of the robot device 300 in the first embodiment, except that the storage unit 350 includes a speaker specification learning result DB 351. FIG. 13 is a diagram illustrating an example of functional blocks of the robot device in the second embodiment. A process performed by the robot device 300 in the second embodiment will be described below by using an example in which the robot device 300 functions as a call device. Furthermore, in the second embodiment, the generation device 200 performs learning for each speaker, and generates information for each speaker and each response character string. Moreover, the learning result DB 221 stores therein a record for each speaker and each response character string.

If the user H10 is an intended party, the acquiring unit 363 acquires information for identifying the user H10. The information for identifying the user H10 as the intended party may be, for example, a phone number set in the call device 100 used by the user H10. Then, the acquiring unit 363 acquires, from the learning result DB 221 of the generation device 200, a response character string, movement data, and a time associated with the user H10 as a speaker, and stores them in the speaker specification learning result DB 351 of the robot device 300. Subsequently, when the driving unit 364 performs driving, the acquiring unit 363 acquires movement data or the like from the speaker specification learning result DB 351.

In the second embodiment, the voice output unit 310 outputs a character string recognized from a voice that is output by the user H10 to the call device 100 connected to the robot device 300. At this time, the movable part 340 of the robot device 300 performs a movement corresponding to the recognized character string.

In this manner, in the second embodiment, when the robot device 300 performs a movement, information indicating a correspondence relationship between voice data and movement data is stored in advance in the storage unit 350. Therefore, upon receiving voice data output from the call device 100, the robot device 300 outputs a voice corresponding to the received voice data, specifies movement data associated with the received voice data by referring to the storage unit 350 that stores therein a correspondence relationship between voice data and movement data, and performs a movement corresponding to the specified movement data.

Furthermore, upon specifying a speaker of the call device 100, the robot device 300 acquires information corresponding to the specified speaker from the storage unit 220 of the generation device 200 that stores therein information indicating a correspondence relationship between voice data and movement data for each speaker, and then stores the acquired information in the storage unit 350. In this case, the storage unit 220 of the generation device 200 is one example of an external storage unit.

Flow of Process

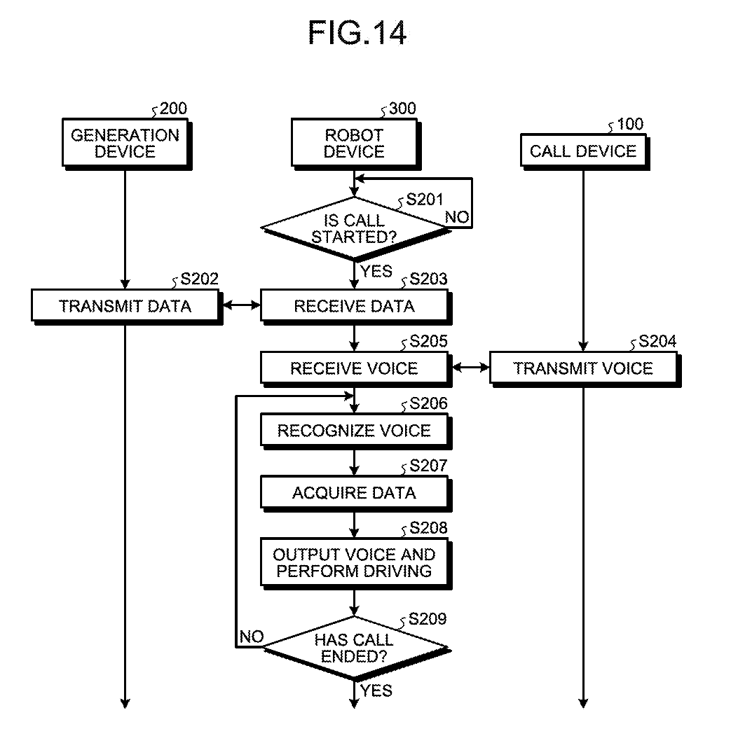

With reference to FIG. 14, the flow of a response process performed by the generation device 200 and the robot device 300 according to the second embodiment will be described. FIG. 14 is a diagram for explaining an example of the response process in the second embodiment. The response process illustrated in FIG. 14 is an exemplary process performed when the user H20 who uses the robot device 300 and the user H10 who uses the call device 100 make a call.

As illustrated in FIG. 14, the robot device 300 waits until a call starts (NO at Step S201). If a call starts (YES at Step S201), the robot device 300 starts a process. At this time, the generation device 200 transmits, to the robot device 300, a piece of data for which the speaker is set to the user H10 among pieces of data on movements stored in the learning result DB 221, in response to a request from the acquiring unit 363 of the robot device 300 (Step S202). Then, the acquiring unit 363 receives data on a movement transmitted by the generation device 200 (Step S203), and stores the received data in the speaker specification learning result DB 351 of the storage unit 350.

During a call, the call device 100 transmits a voice of the user H10 to the robot device 300 (Step S204). The robot device 300 receives the voice transmitted by the call device 100 (Step S205). The voice recognizing unit 361 performs voice recognition on the voice transmitted by the call device 100 (Step S206). The acquiring unit 363 acquires, from the speaker specification learning result DB 351, data on a movement corresponding to a character string recognized by the voice recognizing unit 361 (Step S207). Subsequently, the voice output unit 310 outputs a voice. At this time, the driving unit 364 performs driving based on the data on the movement acquired by the acquiring unit 363 (Step S208).

At this time, if the call has not ended (NO at Step S209), the robot device 300 further receives voice (Step S205). If the call has ended (YES at Step S209), the robot device 300 ends the process.

Effects

In the second embodiment, when a call is made, the robot device 300 acquires data on a movement of an intended party in advance from the generation device 200. Therefore, the robot device 300 and the generation device 200 can reduce the number of repetitions of communication.

### [c] Third Embodiment

While the embodiments of the disclosed technology have been described above, the disclosed technology may be embodied in various different forms other than the embodiments as described above. For example, the detecting unit 140 of the call device 100 may be configured as a device separated from the call device 100. In this case, a device that functions as the detecting unit 140 can capture, by a camera or the like, an image of a user who makes a call by using the call device 100, and detect a movement based on the captured image. Furthermore, the detecting unit 140 may be a wearable device that can detect a movement of a user who is wearing the device.

Furthermore, the generation device 200 may further acquire information on characteristics or an attribute of the user from the call device 100. In this case, the generation device 200 can generate information for each of the characteristics or attributes of the user. For example, a movement performed along with output of a voice may greatly differ depending on the gender or the age of a user. Therefore, by acquiring the gender or the age of a user from the call device 100, the generation device 200 can generate data on a movement for each gender and age. Consequently, the robot device 300 can implement a more wide variety of movements.

Moreover, when a call is made between the call device 100 and the robot device 300, the generation device 200 may transmit, to the robot device 300, movement data corresponding to a voice input to the call device 100. In this case, upon receiving a voice of a speaker, the call device 100 transmits voice data corresponding to the received voice to the robot device 300 and the generation device 200. Then, upon receiving the voice data from the call device 100, the generation device 200 acquires movement data corresponding to the received voice data by referring to the learning result DB 221 that stores therein information indicating a correspondence relationship between an output voice content and movement data, and transmits the acquired movement data to the robot device 300. Then, upon receiving the voice data from the call device 100, the robot device 300 outputs a voice corresponding to the received voice data, and, upon receiving the movement data from the generation device 200, the robot device 300 performs a movement corresponding to the received movement data. Therefore, it is possible to reduce data that is transmitted and received when the robot device 300 makes a call to the call device 100. Furthermore, at this time, the movement data acquired by the generation device 200 in accordance with the voice data is, for example, movement data associated with an output voice content corresponding to the voice data.

All or an arbitrary part of various processing functions executed by the generation device 200 may be implemented by a CPU (or a microcomputer, such as an MPU or a micro controller unit (MCU)). Alternatively, all or an arbitrary part of the various processing functions may be implemented by a program analyzed and executed by a CPU (or a microcomputer, such as an MPU or an MCU), or by hardware using wired logic. Furthermore, the various processing functions executed by the generation device 200 may be implemented by cooperation of a plurality of computers through cloud computing.

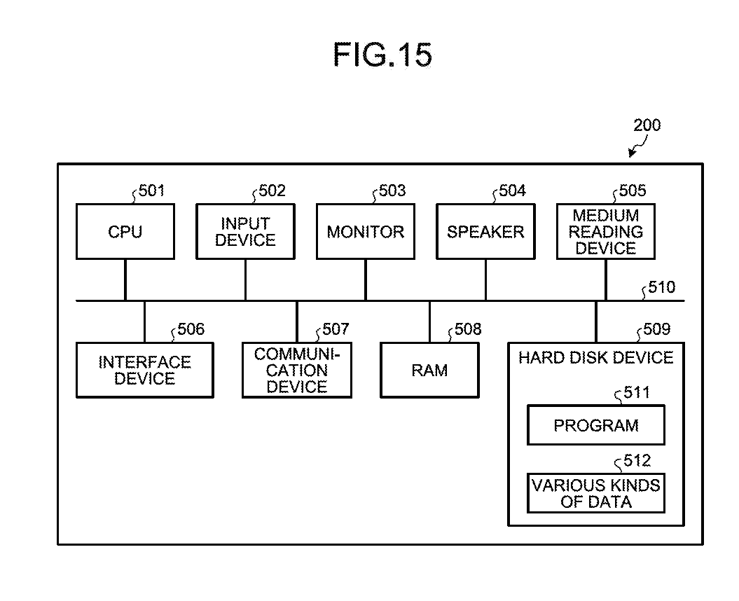

Various processes described in the above-described embodiments may be implemented by causing a computer to execute a program prepared in advance. Therefore, in the following, an example of a computer (hardware) that executes a program having the same functions as those of the above-described embodiments will be described. FIG. 15 is a block diagram illustrating an example of a hardware configuration of the generation device. In FIG. 15, the generation device 200 is illustrated; however, the call device 100 and the robot device 300 can be implemented by the same computer.

As illustrated in FIG. 15, the generation device 200 includes a CPU 501 that performs various kinds of arithmetic processing, an input device 502 that receives input of data, a monitor 503, and a speaker 504. Furthermore, the generation device 200 includes a medium reading device 505 that reads a program or the like from a storage medium, an interface device 506 for connecting to various devices, and a communication device 507 for connecting communication with an external device in a wired or wireless manner. Moreover, the generation device 200 includes a RAM 508 for temporarily storing various kinds of information, and includes a hard disk device 509. Each of the units (501 to 509) in the generation device 200 is connected to a bus 510.

The hard disk device 509 stores therein a program 511 for executing various processes performed by the generating unit 231 described in the above-described embodiments. Furthermore, the hard disk device 509 stores therein various kinds of data 512 (the learning result DB 221 or the like) referred to by the program 511. The input device 502 receives input of operation information from an operator, for example. The monitor 503 displays various screens operated by the operator, for example. The interface device 506 is connected to a printing device or the like, for example. The communication device 507 is connected to the communication network 10, such as a local area network (LAN), and exchanges various kinds of information with an external device via the communication network 10.

The CPU 501 reads the program 511 stored in the hard disk device 509 and loads the program 511 on the RAM 508 to thereby perform various processes. The program 511 does not necessarily have to be stored in the hard disk device 509. For example, the generation device 200 may read and execute the program 511 stored in a storage medium that can be read by the generation device 200. The medium that can be read by the generation device 200 may be, for example, a portable recording medium, such as a compact disc ROM (CD-ROM), a digital versatile disk (DVD), or a universal serial bus (USB) memory, may be a semiconductor memory, such as a flash memory, or may be a hard disk drive, or the like. It may be possible to store the program 511 in a device connected to a public line, the Internet, a LAN, or the like, and cause the generation device 200 to read and execute the program 511 from the device.

According to an embodiment, it is possible to cause a robot device to perform a wide variety of movements.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a control program that causes a computer to execute a process comprising:
controlling a voice of a robot device such that the robot device performs output of a voice based on a predetermined character string; and
controlling a movement of the robot device such that the robot device performs a movement corresponding to the predetermined character string in synchronization with the output of the voice, based on information indicating a correspondence relationship between a character string and a movement, the information being generated based on a character string recognized from a voice of a speaker and data representing a movement of the speaker in a period corresponding to a period in which the voice is output.

2. The non-transitory computer-readable recording medium according to claim 1, wherein the controlling the movement includes controlling the robot device such that the robot device performs a movement corresponding to the predetermined character string, based on a piece of information indicating a correspondence relationship of a specific speaker set in advance among pieces of information indicating a correspondence relationship between a character string and a movement for each speaker, the pieces of the information being generated based on a character string recognized from a voice of a speaker, data representing a movement of the speaker in a period corresponding to a period in which the voice is output, and data for identifying the speaker.

3. The non-transitory computer-readable recording medium according to claim 1, wherein the controlling the movement includes controlling the robot device such that an inclination of a head portion of the robot device matches an inclination corresponding to the predetermined character string, based on information indicating a correspondence relationship between a character string and an inclination, the information being generated based on a character string recognized from a voice of a speaker who uses a call device and data representing an inclination of the call device in a period corresponding to a period in which the voice is output.

4. The non-transitory computer-readable recording medium according to claim 1, wherein
the controlling the voice includes controlling the robot device such that the robot device outputs a first character string recognized from a voice that is output by a first speaker to a call device connected to the robot device, and
the controlling the movement includes executing a process of controlling the robot device such that the robot device performs a movement corresponding to the first character string.

5. A non-transitory computer-readable recording medium storing a control program that causes a computer to execute a process comprising:
causing a robot device to receive voice data output from a call device, output a voice corresponding to the received voice data, specify movement data corresponding to the received voice data by referring to a storage that stores therein information indicating a correspondence relationship between voice data and movement data, and perform a movement corresponding to the specified movement data.

6. The non-transitory computer-readable recording medium according to claim 5, wherein
the process further includes:
acquiring, when a speaker of the call device is specified, information corresponding to the specified speaker from an external storage that stores therein information indicating a correspondence relationship between voice data and movement data for each speaker; and
storing the acquired information in the storage.

7. A control method comprising:
controlling a voice of a robot device such that the robot device performs output of a voice based on a predetermined character string, by a processor;
controlling a movement of the robot device such that the robot device performs a movement corresponding to the predetermined character string in synchronization with the output of the voice, based on information indicating a correspondence relationship between a character string and a movement, the information being generated based on a character string recognized from a voice of a speaker and data representing a movement of the speaker in a period corresponding to a period in which the voice is output, by the processor.

8. A non-transitory computer-readable recording medium storing a control program that causes a computer to execute a process comprising:
causing a robot device to receive voice data output from a call device, output a voice corresponding to the received voice data, specify movement data corresponding to the received voice data by referring to a storage that stores therein information indicating a correspondence relationship between voice data and movement data, and perform a movement corresponding to the specified movement data.

9. A robot device comprising:
a processor configured to:
perform output of a voice based on a predetermined character string; and
perform a movement corresponding to the predetermined character string in synchronization with the output of the voice, based on information indicating a correspondence relationship between a character string and a movement, the information being generated based on a character string recognized from a voice of a speaker and data representing a movement of the speaker in a period corresponding to a period in which the voice is output.

10. A robot device comprising:
a processor configured to:
receive voice data output from a call device, and output a voice corresponding to the received voice data; and
upon output of the voice, specify movement data associated with the received voice data by referring to a storage that stores therein information indicating a correspondence relationship between voice data and movement data, and perform a movement corresponding to the specified movement data.
